(19) United States
(12) Patent Application Publication
(10) Pub. No.: US 2025/0252398 A1
(43) Pub. Date: Aug. 7, 2025

(54) SELF-SERVICE CLIENT ONBOARDING PLATFORM

(71) Applicant: Wells Fargo Bank, N.A., San Francisco, CA (US)

(72) Inventors: Charlene C. Balfour, New York, NY (US); Niladri Bhattacharya, Livingston, NJ (US); Frank H. Dix, New York, NY (US)

(21) Appl. No.: 18/431,401

(22) Filed: Feb. 2, 2024

(51) Int. Cl. G06Q 10/10; G06F 9/451; H04L 9/00

(52) U.S. Cl. CPC G06Q 10/10; G06F 9/451; H04L 9/50; G06Q 2220/00

(57) ABSTRACT

Systems and techniques for are described herein. An application programming interface (API) gateway receives an onboarding request from a self-service onboarding portal. Requirements data is queried for onboarding requirements. The onboarding requirements are deduplicated based on a common taxonomy to create a standardized requirements set. User interface elements are selected for presentation in a user interface based on the standardized requirements set. The user interface is presented in the self-service onboarding portal. An onboarding workflow is executed across internal systems to fulfill the requirements using input received from the user interface. A status of the onboarding request is returned to the self-service onboarding portal.

### TECHNICAL FIELD

Embodiments described herein generally relate to artificial intelligence in computing platforms and, in some example embodiments, enterprise platforms and architectures for streamlining client onboarding processes using artificial intelligence.

### BACKGROUND

Wholesale client onboarding for complex organizations is often a fragmented, manual process involving multiple client touchpoints and systems. Relationship managers interface directly with clients to configure products and services across groups like know your customer (KYC), credit, compliance, etc. This leads to an inconsistent, opaque experience for clients. Current onboarding processes have various shortcomings. Clients receive excessive, uncoordinated requests across groups asking for duplicate information. Clients may be offered a confusing array of product offerings that poorly match needs of the client. There may be varying workflows processed across intake channels (e.g., branch, mobile, sales, etc.). There may be a lack of end-to-end process transparency into fulfillment status of onboard requests with a heavy reliance on manual forms and data re-entry prolonging the onboarding process. There is a need for a holistic onboarding platform that provides consistent client treatment, transparency, digitization, and reuse of existing fulfillments across groups.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment and a system for a, according to an embodiment.

FIG. 2 is a block diagram that illustrates an example data flow for a, according to an embodiment.

FIG. 3 illustrates an example machine learning component for configuration option recommendation selection for a, according to an embodiment.

FIG. 4 illustrates an example of a method for a, according to an embodiment.

FIG. 5 is a block diagram illustrating an example of a machine upon which one or more embodiments may be implemented.

### DETAILED DESCRIPTION

Current client onboarding processes present clients with excessive uncoordinated requests across organizational groups that ask for duplicate information. Clients may be offered a confusing array of product offerings that poorly match their needs. Varying workflows are processed across intake channels (e.g., branch, mobile, sales, etc.) resulting in unnecessary duplicate processing with a lack of end-to-end process transparency into fulfillment status of onboard requests. There may be a heavy reliance on manual forms and data re-entry prolonging the onboarding process.

The systems and techniques discussed herein address the shortcomings of current client onboarding processes by providing seamless digital client outreach, accurate client identification and data reuse, aggregation and deduplication of onboarding requirements, process orchestration and status transparency using artificial intelligence (AI)/machine learning (ML) for data extraction and auto-population.

The system architecture of the client onboarding platform includes an application programming interface (API) gateway layer, an enterprise services layer, a requirements aggregation and deduplication engine, a process workflow orchestration manager, and a data classification taxonomy to normalize requirements and data across groups and various systems. Transaction may be recorded in a distributed ledger, portable digital client identifiers may be generated for clients during onboarding, client risk assessments may be shared between groups, and consent-based data sharing may be enabled across institutions.

Distributed ledger technology (DLT), commonly associated with blockchain, offers a secure and immutable way to record and share data across a network of participants. In client onboarding, DLT can be used to create a shared, reliable source of client data that can be accessed by various parties involved in the onboarding process.

For instance, when a client is onboarded, their identity verification, due diligence documents, and compliance checks are recorded on the distributed ledger. This information can then be accessed by different departments within the bank, such as credit, KYC, and account opening teams, without the need for redundant data requests to the client. This not only streamlines the onboarding process but also ensures that the data is consistent and up-to-date across all departments.

Moreover, DLT can facilitate regulatory reporting and compliance by providing regulators with access to a tamper-proof audit trail of all onboarding-related activities. This transparency can help in quickly addressing regulatory inquiries and reducing the risk of non-compliance. Additionally, the use of smart contracts on distributed ledgers can automate certain onboarding tasks, such as triggering the next steps in the workflow once certain conditions are met, further increasing efficiency and reducing the potential for human error. The use of distributed ledgers in client onboarding can lead to improvements in data integrity, process efficiency, and regulatory compliance, positioning the organization to better manage risks and provide a better client experience.

Complex onboarding may involve long processing times (e.g., up to 37 days, etc.) to onboard a new client. This is because the onboarding process may span multiple different systems that do not communicate with each other. A plugin framework is provided that customizes the onboarding process depending on what products/services the client is seeking. The plug-in framework reduces software coding, reduces data storage complexity, and increases scalability of onboarding services. The systems and techniques discussed herein consolidate outreach across groups into a single digital channel for unified communications to eliminate excessive emails from different teams. Clients are uniquely identified across domains to reduce repeat data requests. Relationships are identified in existing systems to maximize reuse. Requirements are gathered from all domains in a centralized manner. Requirements may include, by way of example and not limitation, personal data elements, security controls, system access elements, data verification elements, identity validation elements, and the like. A consistent taxonomy is applied to deduplicate across groups. Existing fulfillments are reused wherever possible. Onboarding workflows are centrally orchestrated across groups. End-to-end process transparency is provided through detailed instrumentation. AI/ML is used for data extraction, classification, and autofill. External data sources are integrated to minimize manual entry.

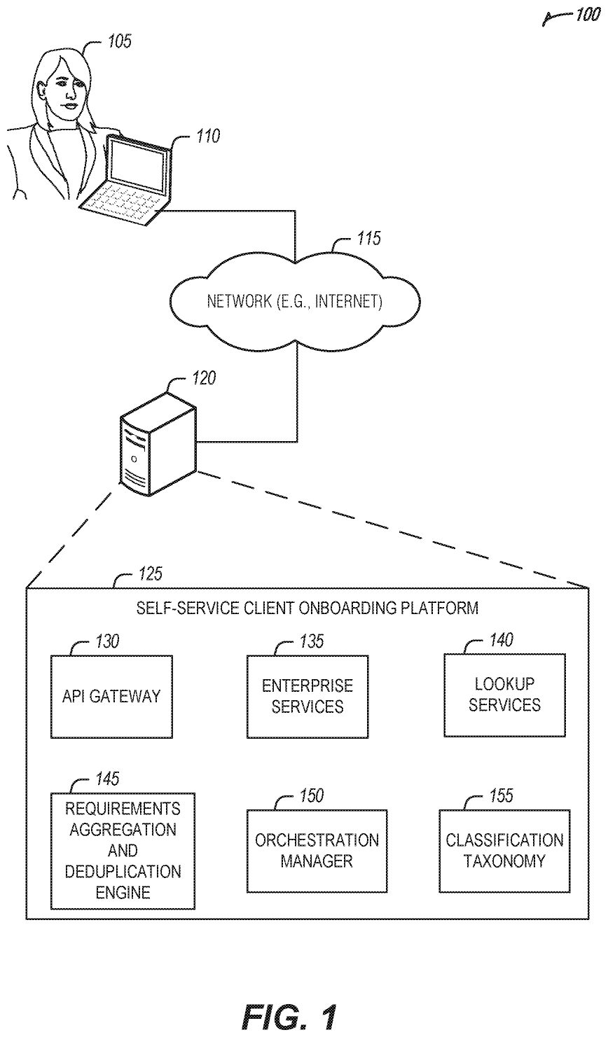

FIG. 1 is a block diagram of an example of an environment 100 and a system 125 for a, according to an embodiment. The environment 100 includes a user 105 (e.g., a customer, client, etc.) interacting with a user computing device 110 (e.g., a laptop, a desktop, a tablet, a smartphone, a kiosk, etc.) that is communicatively coupled to a server computing device 120 (e.g., a standalone server computing device, a cloud computing platform, a distributed computing platform, a virtualized computing platform, a field programmable gate array (FPGA), a system on chip (SoC), an application specific integrated circuit (ASIC), etc.) via a network 115. The server computing device 120 includes a system 125. In an example, the system is a self-service client onboarding platform.

The system 125 includes a variety of components including an API gateway 130, enterprise services 135, lookup services 140, a requirements aggregation and deduplication engine 145, an orchestration manager 150, and a classification taxonomy 155. The components of the system 125 may be executing on a single server computing device 120 or may be distributed across a variety of server computing devices 120 that may execute one or more components, a portion of a component, etc.

The API gateway 130 provides a simplified set of interfaces that enable external client channels and portals to integrate with the onboarding platform. This services-based approach encapsulates the complexity of the orchestration layer and backend systems behind well-defined APIs. The API gateway 130 may include a variety of APIs including, by way of example and not limitation, an onboarding API that allows channels to initiate a new onboarding request and receive a unique identifier in return. The channels send minimum details like client name, type, and contact information to kick off orchestration; a requirements API that channels can call and pass details like products selected, geography, etc. to get back aggregated data and document collection requirements. The requirements API leverages the requirements aggregator and deduplication capabilities internally; and a status API that channels use to check real-time fulfillment status by passing an onboarding request ID. The status API taps into orchestration instrumentation to return integrated progress across account opening, KYC, credit, and other downstream groups.

The API gateway 130 enables isolation from underlying complexity of workflows, consistent experience across channels (e.g., mobile, web, branch, etc.), dynamic user interface (UI) rendering based on requirements metadata, support for contextual widget-based displays, and easy extensibility to third-party channel applications. The API gateway 130, through its simplified but powerful APIs, future-proofs onboarding capabilities and prevents fragmentation by enforcing conformance to canonical data models. It balances business-friendly interfaces with high degrees of configurability and customization via channel mapping and persona-based displays.

Enterprise services 135 consists of reusable business services that implement common functions needed across multiple onboarding domains. By encapsulating these common capabilities, the enterprise services 135 enable standardized approaches and simplify integration complexity for consuming systems. The enterprise services may include a variety of services including, by way of example and not limitation, a client identification service that is responsible for establishing a unique firm-wide ID for users, leverages internal and external data sources to accurately resolve identities, and enforces consistent customer reference data policies; reference data services provide access to authoritative sources for products, pricing, market data, legal entities, and other domains and allows groups to operate on common real-time information; risk analysis services execute various risk processing including KYC validation, sanctions screening, credit adjudication, and other checks needed to clear users and implements firm-wide standards and combines data across groups.

The enterprise services 135 data enrichment, document digitization, and customer communications and notifications. The enterprise services 135 may work in conjunction with the lookup services 140 to interface with internal and third-party data sets. Enterprise services 135 enable standardization and reuse across business lines, increased data quality and consistency, shared real-time access to critical business data, reduced duplication across products and channels, loose coupling and encapsulation of complex logic, and accelerated integration of new capabilities. By using a services orientation, the onboarding platform prevents fragmented and redundant implementations across business groups. The approach balances standardization with configurability to meet diverse needs of customers and organizational groups.

The lookup services 140 communicate with the requirements aggregation and deduplication engine 145 to prevent prompting the user 105 for known information during onboarding. For example, the user 105 may have different products (e.g., a mortgage, etc.), so basic KYC data may be known for the user 105 (e.g., social security number (SSN), birthday, address, etc.) and the known information may be pre-filled in onboarding forms. The lookup services 140 may transmit requests to external data sources (e.g., business data aggregators, Secretaries of State databases, etc.) to pull user data from known and trusted services. If the requirements aggregation and deduplication engine 145 leverages this known data, it may be pre-filled in the onboarding forms and the user 105 may be prompted to verify the pre-filled data.

The requirements aggregation and deduplication engine 145 receives requested services/products that the user 105 has opted to obtain and creates required information for know your client (KYC) and onboarding across the requested products and services. This prevents the user 105 from being prompted more than once for a question that is present in multiple products. For example, if the user 105 wants both a checking account and a credit card, the user 105 is only prompted to provide basic information (e.g., business name, address, etc.) once. The requirements aggregation and deduplication engine 145 uses data from prior customers having similar profiles and AI to learn/customize forms based on similarly situated users that were successfully onboarded in the past.

Based on the onboarding request and the data returned by the requirements aggregation and deduplication engine 145, an onboarding form may be customized based on (1) the specific services requested and (2) known/verified information that exists for the user 105. This reduces the amount of documents/information that needs to be provided by the user 105 and that need to be verified by a representative of the organization that may be called on to assist with the onboarding process.

The requirements aggregation and deduplication engine 145 is responsible for consolidating and streamlining data and document collection requests from diverse downstream groups. For example, during client onboarding, the KYC, credit, and account opening teams may all need certain common pieces of information like incorporation certificates and financial statements. Without an aggregated requirements approach, users endure repetitive manual requests from relationship managers across these groups. The requirements aggregation and deduplication engine 145 addresses this by providing a dynamic registry that helps discover requirements services that participating groups expose. These groups agree to the classification taxonomy 155 for classifying data attributes and documents uniformly. For instance, a “Certificate of Incorporation” document in the KYC domain is normalized to the standardized name “Registration_Certificate” in the classification taxonomy 155. The requirements aggregation and deduplication engine 145 leverages this to query groups for their requirements and deduplicate overlapping requests. If KYC and credit both require articles of incorporation documents, the redundancy is removed.

The requirements aggregation and deduplication engine 145 checks if requirements are already fulfilled with existing data available internally across enterprise systems or externally from digital sources and applies threshold-based rules to only surface the incremental requirements. The requirements aggregation and deduplication engine 145 leverages various AI techniques to further streamline and enhance the aggregation process including, by way of example and not limitation, fuzzy logic algorithms that allow matching information requests and collected documents to classification taxonomy 155 definitions in a flexible manner. For instance, a “Business License” can be mapped to the standardized “Registration Certificate” concept through fuzzy matching. This avoids exact name matches and uses similarity scoring to reconcile differences; supervised ML models may be trained on hundreds of thousands of historical onboarding instances to predict the probability of certain attributes being requested by downstream groups. These propensity scores minimize supplemental requests through likelihood forecasting; natural language processing (NLP) techniques parse unstructured documents like bank statements, underwriting summaries, credit memos etc. to extract salient entities. These can reveal additional details about the user 105 to fulfill implicit data needs across groups.

The continuous feedback loop of requirements aggregation and deduplication engine 145 usage further retrains the AI models-increasing their accuracy while leveraging anonymized data safeguards to prevent bias or skew. The infusion of AI makes the requirements aggregation and deduplication engine 145 smarter and the overall requirements gathering process faster and more predictive-reducing user 105 effort and increasing fulfillment rates. The models exhibit “learning over time” becoming familiar with group specifics and adapting dynamically rather than through rigid rules. As new groups like taxation, compliance, or lending are onboarded, they register their requirements services with the dynamic registry. The services conform to the classification taxonomy 155 allowing seamless aggregation by the platform. The requirements aggregation and deduplication engine 145 capabilities reduce redundant gathering, minimize requests through reuse, and streamline end-to-end data collection across groups-delivering an integrated and transparent requirements acquisition process.

The orchestration manager 150 serves as a coordination hub that manages interactions between services, systems of record, and downstream implementation workflows. The orchestration manager 150 allows defining end-to-end business processes that stitch together capabilities needed for client onboarding. Workflows execute step-by-step orchestrating data exchange and handoffs across groups that own accounts, KYC, credit, taxation, compliance and other domains. The orchestration manager 150 models the workflows visually using business-friendly notations; embeds business rules, decisions, and policy enforcement points; integrates with services that abstract complex functions; leverages process analytics for continuous efficiency gains; maintains an audit trail across end-to-end execution; and exposes instrumentation data for status visibility. The orchestration manager 150 enables encapsulation of complex system interactions; acceleration through asynchronous, parallelized processing; increased transparency into fulfillment; consistent execution and adherence to standards; and responsiveness to change via configurable workflows. By serving as the connective tissue across systems, the orchestration manager 150 creates harmony; allowing the platform to scale across business lines in a plug-and-play fashion by integrating existing and new services rapidly. The orchestration manager 150 handles the end-to-end workflow orchestration once requirements have been identified. It interfaces with downstream domain systems to execute the necessary steps and instruments the processes for status visibility and recording on a distributed ledger.

The classification taxonomy 155 serves as a canonical model that standardizes information concepts related to client onboarding across business lines. It provides a centralized semantic layer to govern consistent definitions and usage of data elements. By mapping group-specific data representations from domains like KYC, credit, account opening etc. to the classification taxonomy 155, synergies can be unlocked to facilitate uniform interpretation and shared understanding across teams. The classification taxonomy 155 provides a single source of truth for data elements like customer, product, contract etc. and consistent classification of data attributes as public/private/restricted. The classification taxonomy 155 enables embedding metadata like descriptions, tags, validation rules etc. and drives user interfaces and forms through metadata exposure. Crosswalking is enabled between specific schemas to the classification taxonomy 155 to enable identification of data relationships and lineages.

The classification taxonomy 155 increases data interoperability reducing fragmentation, accelerates integration of new data domains; improves analytics from linkage of related concepts, lowers costs through redundancies elimination, and enhances data governance via central oversight. The classification taxonomy 155 is expanded iteratively as new segments adopt the classification taxonomy 155. AI techniques facilitate matching and mapping of new domains to the canonical representation. By harmonizing semantics, the classification taxonomy 155 breaks down data silos and removes disconnects across business lines.

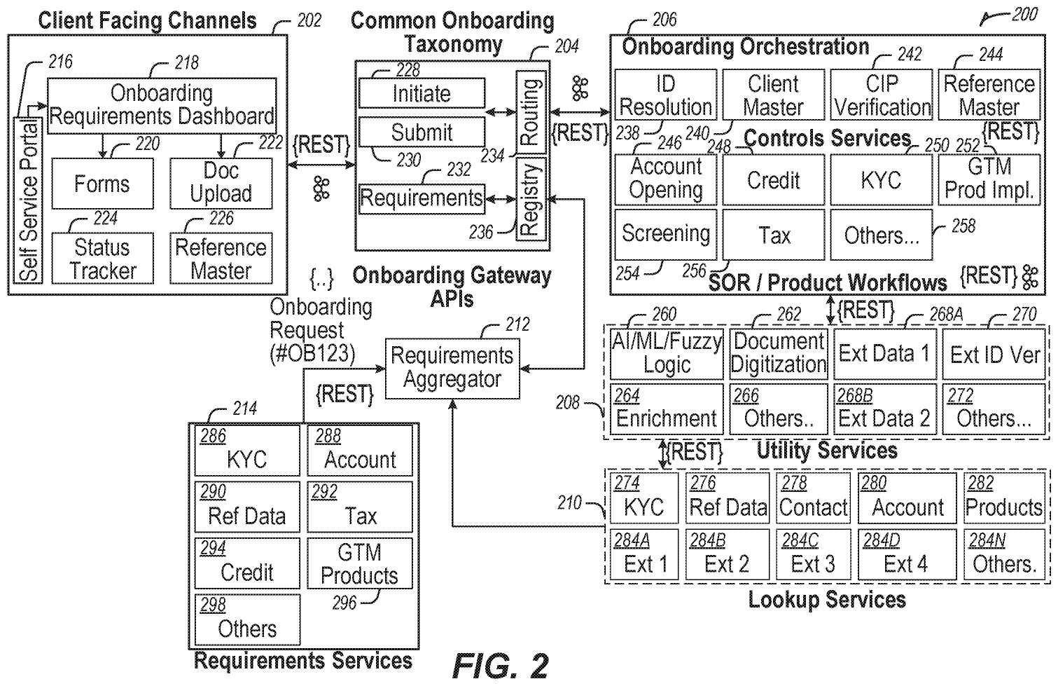

FIG. 2 is a block diagram that illustrates an example data flow 200 for a, according to an embodiment. The data flow 200 illustrates the movement of data among client facing channels 202, a common onboarding taxonomy 204 (e.g., the classification taxonomy 155 as described in FIG. 1, etc.), onboarding orchestration 206 (e.g., the orchestration manager 150 as described in FIG. 1, etc.), utility services 208, lookup services 210 (e.g., the lookup services 140 as described in FIG. 1, etc.), a requirements aggregator 212 (e.g., the requirements aggregation and deduplication engine 145 as described in FIG. 1, etc.), and requirements services 214.

The client facing channels 202 may include a self-service portal 216 that includes a user interface that is accessible by a client (e.g., the user 105 as described in FIG. 1, etc.) for requesting a product or service. The self-service portal 216 works in conjunction with an onboarding requirements dashboard 218 to obtain interface elements for the user interface that may include forms 220, a document upload interface 222, a status tracker 224, and a reference master 226. The client enters minimum requirements (e.g., name, address, tax id., etc.) and an onboarding APIs of an API gateway (e.g., the API gateway 130 as described in FIG. 1, etc.) is accessed to submit an onboarding request and to obtain a unique Request ID using the common onboarding taxonomy 204.

The onboarding APIs initiate the onboarding process and obtain requirements from the requirements aggregator 212 and straight-trough processing (STP) data to onboarding from the client facing channels 202. The common onboarding taxonomy 204 provides data and document classifications that normalize system specific schemas. The common onboarding taxonomy 204 includes initiation standards 228, submission standards 230, standardized requirements 232, routing data 234, and registry data 236. The standardized requirements 232 are developed using requirements services 214 that feed data into the requirements aggregator 212. The requirements services 214 may include KYC requirements 286, account requirements 288, reference data requirements 290, tax requirements 292, credit requirements 294, GTM product requirements 296, and requirements for other products and services 298.

Onboarding orchestration 206 manages interactions between services and systems of record (SORs) and product implementation workflows. Onboarding orchestration 206 establishes an identify of the client and relationship of the client with the organization using internal and external data sources. Supporting services include controls that ensure adherence to regulatory and firmwide reference data controls, domain specific requirements SOR/product implementation provided services, utility services 208 that provide data enhancement such as data enrichment and digitization, and lookup services 210 that provide arbitrated lookup against internal and external data and document sources. Onboarding orchestration 206 establishes an identity of the client and relationship of the client with the organization using internal and external data sources. The onboarding orchestration 206 may include a variety of control services including, but not limited to, ID resolution 238, client master 240, customer identification program (CIP) verification 242, and a reference master 244. The control services of the onboarding orchestration 206 may interact with a variety of systems of record (SORs) and product workflows including, by way of example and not limitation, account opening 246, credit 248, KYC 250, go to market (GTM) product implementations 252, screening 254, tax 256, and others 258.

The onboarding orchestration 206 may leverage a variety of utility services 208 that include, by way of example and not limitation, AL/ML/fuzzy logic 260, document digitization 262, data enrichment 264, other data services 266, a variety of external data sources 268A and 268B, external ID verification services 270, and other external data sources 272 that may provide information about a client that may be used to reduce the information to be input by the client. The onboarding orchestration 206 may leverage a variety of lookup services 208 that include, by way of example and not limitation, KYC 274, reference data 276, contact data 278, account data 280, product data 282, data from a variety of external data sources 284A, 284B, 284C, 284D, and 284N.

If required, a client identifier is created and CIP is verified. The onboarding APIs return the established identity and relationships back to the UI presented to the client. The UI collect customer selections for product, account, and contacts and calls the onboarding APIs with customer selections to retrieve aggregated data and document requirements via the requirements aggregator 212. The client provides required data and documents using the dynamic UI. The UI calls the onboarding APIs with customer provided data and uploaded documents and the onboarding orchestration 206 distributes data to SOR or product implementation workflows. The SOR or product implementation workflows share real-time statuses with the UI through the onboarding orchestration 206 to provide comprehensive status tracking.

When the client submits a request, the client facing channels 202 transmits a request to the common onboarding taxonomy 204 and a unique request ID is created and transmitted back to the client facing channels 202. The request is transmitted to the onboarding orchestration 206 using the common onboarding taxonomy 204. The ID resolution 238 confirms the identity of the client and the relationship with the firm using the lookup services 210. The client master 240 supplements the client reference data, and the CIP verification 242 creates and/or verified a client identifier. The onboarding gateway APIs return established identity and relationship data to the client facing channels 202 using the common onboarding taxonomy 204.

The UI of the self-service portal 216 collects client selections for product, account, and contacts. The client facing channels 202 transmits an API call to the onboarding APIs using the common onboarding taxonomy 204 with customer selections to retrieve aggregated data and document requirements compiled by the requirements aggregator 212 using the requirements services 214. The aggregated requirements are transmitted to the client facing channels 202 via the onboarding APIs using the common onboarding APIs.

UI elements are presented in the UI of the self-service portal 216 according to the aggregated requirements using the forms 220 and the document upload interface 222. The client inputs the requested data and documents and the client facing channels transmits the data using to the common onboarding taxonomy 204 for standardization and transmission to the onboarding orchestration 206 using the onboarding APIs to distribute the data and documents to the SORs and product implementation workflows.

The SOR and product implementation workflows share real-time statuses with the self-service client portal 216 via the onboarding orchestration 206. The self-service client portal 216 displays internal dashboards that include internal service level agreements status and escalation triggers.

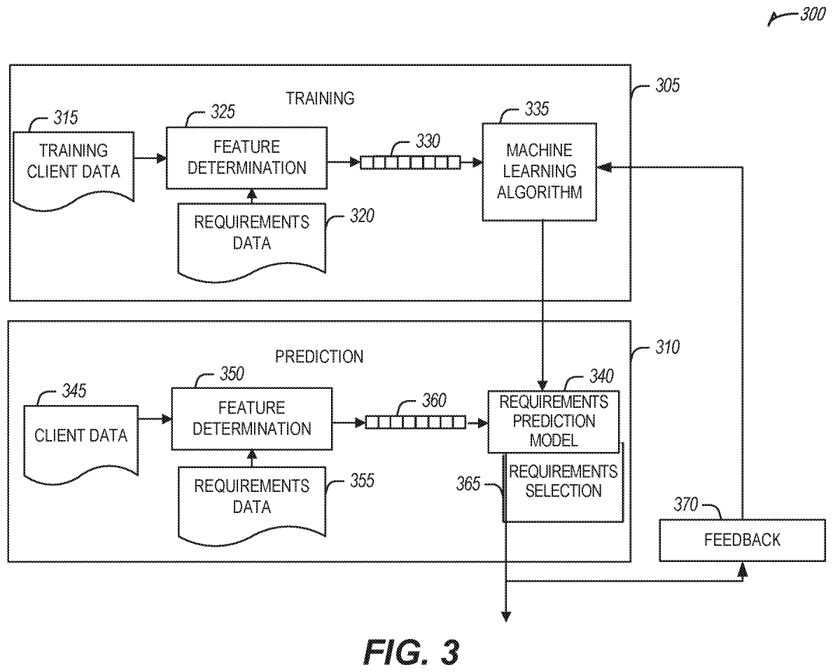

FIG. 3 illustrates an example machine learning component 300 for configuration option recommendation selection for, according to an embodiment. The machine learning component 300 may be a component of the system 125 as described in FIG. 1 and may be used in conjunction with the requirements aggregator and deduplication engine 145 as described in FIG. 1. The machine learning component utilizes a training module 305 and a prediction module 310. Training module 305 feeds training client data 315 and requirements data 320 into feature determination module 325 which determines one or more features 330 from this information. Features 330 are a subset of the information input and is information determined to be predictive of relevant requirements for a client based on previously requirements selected for similarly situated clients (e.g., having similar client data, etc.). Examples include one or more of client type, relationship data, client product and service mix, client demographics, etc.

The machine learning algorithm 335 produces a requirements prediction model 340 based upon the features and feedback 370 associated with those features. For example, the features associated with past requirements selected for past clients are used as a set of training data. As noted above, the requirements prediction model 340 may be for the entire system (e.g., built of training data accumulated throughout the entire system, regardless of the user for which a resource is being selected), or may be built specific for each user, user group, project type, file type, etc.

In the prediction module 310, the current client data 345 (e.g., data describing the current client, etc.) may be input to the feature determination module 350. Similarly applicable requirements data 355 is also input to the feature determination module 350. Feature determination module 350 may determine the same set of features or a different set of features as feature determination module 325. In some examples, feature determination module 350 and 325 are the same module. Feature determination module 350 produces features 360, which are input into the requirements prediction model 340 to requirements selection 365. The training module 305 may operate in an offline manner to train the requirements prediction model 340. The prediction module 310, however, may be designed to operate in an online manner as each set of client data is evaluated as onboarding events occur.

It should be noted that the requirements prediction model 340 may be periodically updated via additional training and/or user feedback 370. The user feedback 370 may be feedback from users that provide explicit feedback (e.g., responses to questions about whether a requirement was relevant, etc.) or may be automated feedback 370 based on outcomes of the selected requirements selected for the client. For example, a user submitting an onboarding request may provide an explicit response indicating that the requirement was not necessary or a staff member of an organization may provide the feedback during review of the onboarding process and the response may be used as additional training data for updating the requirements prediction model 340.

The machine learning algorithm 335 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, linear classifiers, quadratic classifiers, k-nearest neighbor, linear regression, and hidden Markov models. Examples of unsupervised learning algorithms include expectation-maximization algorithms, vector quantization, and information bottleneck method. In an example embodiment, a multi-class logistical regression model is used.

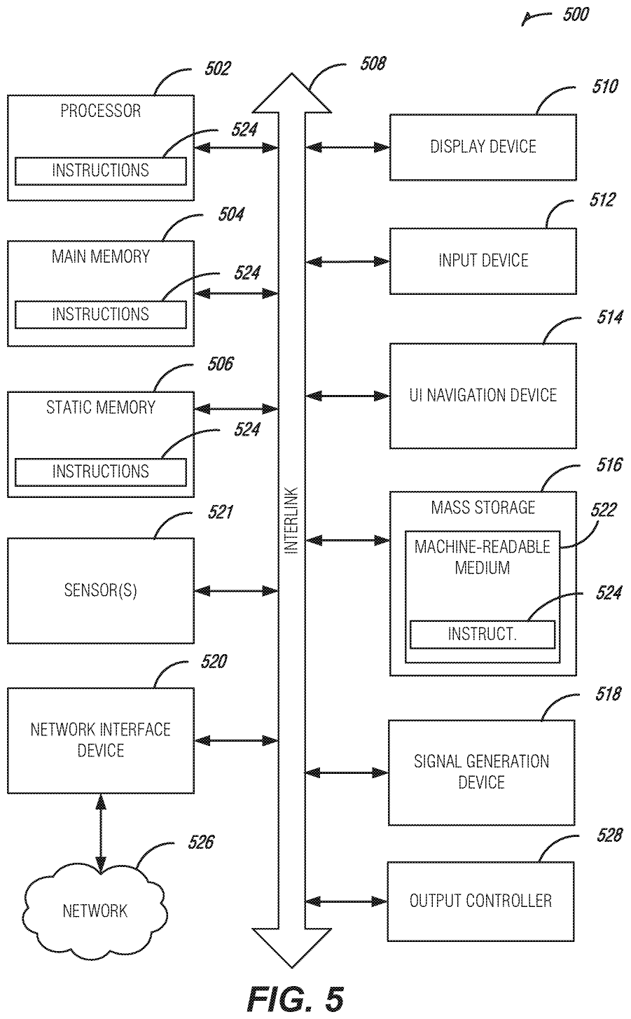

The system 125 as described in FIG. 1 and the machine learning component 300 may be implemented on one or more computing devices, such as machine 500 of FIG. 5. As such, some of the components of FIG. 1 may communicate with each other via inter-process communication and other local communications techniques (e.g., shared memory, pipes, buffers, queues). In other examples, the components of FIG. 1 may be parts of different services or systems and thus the components may communicate with each other through a computer network using computer networking protocols.

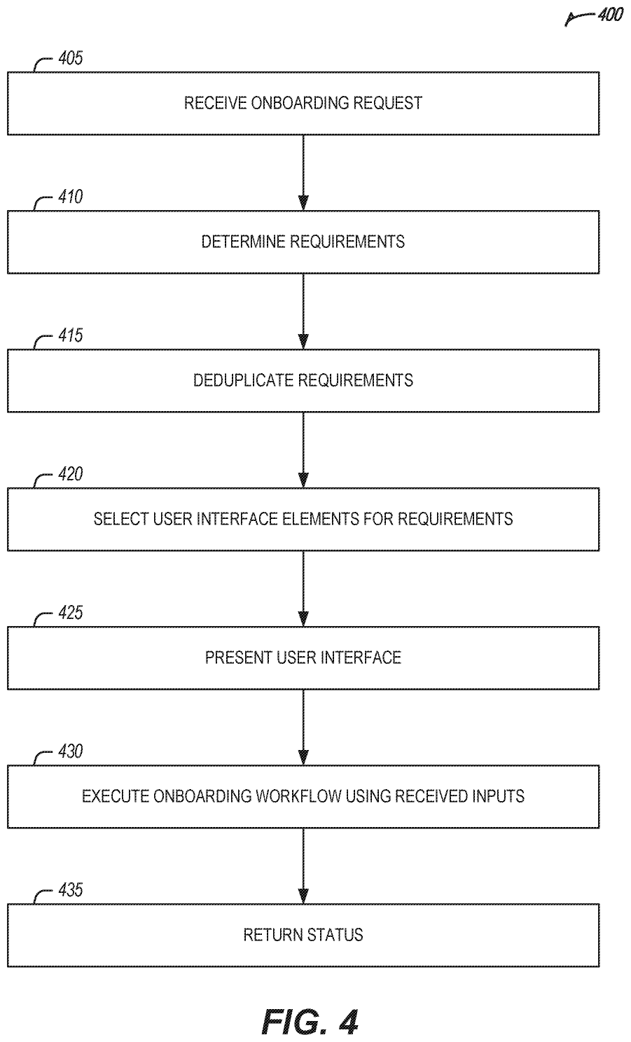

FIG. 4 illustrates an example of a method 400 for a, according to an embodiment. The method 400 may provide features as described in FIGS. 1 to 3.

An application programming interface (API) gateway receives an onboarding request from a self-service onboarding portal (e.g., at operation 405). In an example, client data may be extracted from the onboarding request. It may be determined that a client identifier does not exist for the client data. A unique client identifier may be generated for the client using the client data and the unique client identifier may be associated with the onboarding request.

Requirements data is queried for onboarding requirements (e.g., at operation 410). In an example, a requirements prediction model is trained by a machine learning algorithm using historical client data and historical requirements data. Client data is extracted from the onboarding request. The client data is evaluated using the requirements prediction model to determine the onboarding requirements and the onboarding requirements are retuned in response to the query.

The onboarding requirements are deduplicated based on a common taxonomy to create a standardized requirements set (e.g., at operation 415). In an example, a fuzzy logic algorithm may be applied to the onboarding requirements using the common onboarding taxonomy to create a map of a plurality of requirement elements to a requirement element of the common onboarding taxonomy. The plurality of requirement elements may be replaced with the requirement element of the common onboarding taxonomy ion the standardized set of onboarding requirements.

User interface elements are selected for presentation in a user interface based on the standardized requirements set (e.g., at operation 420). In an example, the user interface elements may include a form or a document upload interface. The user interface is presented in the self-service onboarding portal (e.g., at operation 425).

An onboarding workflow is executed across internal systems to fulfill the requirements using input received from the user interface (e.g., at operation 430). A status of the onboarding request is returned to the self-service onboarding portal (e.g., at operation 435). In an example, a system of record may be determined to receive a data element included in the input received from the user interface. The data element may be transmitted to the system of record. A status response may be obtained from the system of record and the status response may be compiled with a collection of status responses from the internal systems to generate the status. In an example, an onboarding request block may be generated for the onboarding request in a distributed ledger and the onboarding request block may be updated with the status.

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensors. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. In an example, machine readable media may exclude transitory propagating signals (e.g., non-transitory machine-readable storage media). Specific examples of non-transitory machine-readable storage media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, LoRa®/LoRaWAN® LPWAN standards, etc.), IEEE 802.15.4 family of standards, peer-to-peer (P2P) networks, 3rd Generation Partnership Project (3GPP) standards for 4G and 5G wireless communication including: 3GPP Long-Term evolution (LTE) family of standards, 3GPP LTE Advanced family of standards, 3GPP LTE Advanced Pro family of standards, 3GPP New Radio (NR) family of standards, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

### Additional Notes

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A system for client onboarding comprising:
at least one processor; and
memory comprising instructions that, when executed by the at least one processor, cause the at least one processor to perform operations to:
receive, at an application programming interface (API) gateway, an onboarding request from a self-service onboarding portal;
query requirements data for onboarding requirements;
deduplicate the onboarding requirements based on a common taxonomy to create a standardized requirements set;
select user interface elements for presentation in a user interface based on the standardized requirements set;
present the user interface in the self-service onboarding portal;
execute an onboarding workflow across internal systems to fulfill requirements of the standardized requirements set using input received from the user interface; and
return a status of the onboarding request to the self-service onboarding portal.

2. The system of claim 1, the memory further comprising instructions that, when executed by the at least one processor, cause the at least one processor to perform operations to:
train, using a machine learning algorithm, a requirements prediction model using historical client data and historical requirements data;
extract client data from the onboarding request;
evaluate the client data using the requirements prediction model to determine the onboarding requirements; and
return the onboarding requirements in response to the query.

3. The system of claim 1, the memory further comprising instructions that, when executed by the at least one processor, cause the at least one processor to perform operations to:
extract client data from the onboarding request;
determine that a client identifier does not exist for the client data;
generate a unique client identifier for a user using the client data; and
associate the unique client identifier with the onboarding request.

4. The system of claim 1, the instructions to deduplicate the onboarding requirements based on a common taxonomy to create a standardized requirements set further comprising instructions to:
apply a fuzzy logic algorithm to the onboarding requirements using the common taxonomy to create a map of a plurality of requirement elements to a requirement element of the common taxonomy; and
replace the plurality of requirement elements with the requirement element of the common taxonomy from the standardized requirements set.

5. The system of claim 1, wherein the user interface elements include a document upload interface.

6. The system of claim 1, the instructions to execute the onboarding workflow across internal systems to fulfill requirements of the standardized requirements set using input received from the user interface further comprising instructions to:
determine a system of record to receive a data element included in the input received from the user interface;
transmit the data element to the system of record;
obtain a status response from the system of record; and
compile the status response with a collection of status responses from the internal systems to generate the status of the onboarding request.

7. The system of claim 1, the memory further comprising instructions that, when executed by the at least one processor, cause the at least one processor to perform operations to:
generate an onboarding request block for the onboarding request in a distributed ledger; and
update the onboarding request block with the status of the onboarding request.

8. At least one non-transitory machine-readable medium comprising instructions for client onboarding that, when executed by at least one processor, cause the at least one processor to perform operations to:
receive, at an application programming interface (API) gateway, an onboarding request from a self-service onboarding portal;
query requirements data for onboarding requirements;
deduplicate the onboarding requirements based on a common taxonomy to create a standardized requirements set;
select user interface elements for presentation in a user interface based on the standardized requirements set;
present the user interface in the self-service onboarding portal;
execute an onboarding workflow across internal systems to fulfill requirements of the standardized requirements set using input received from the user interface; and
return a status of the onboarding request to the self-service onboarding portal.

9. The at least one non-transitory machine-readable medium of claim 8, further comprising instructions that, when executed by the at least one processor, cause the at least one processor to perform operations to:
train, using a machine learning algorithm, a requirements prediction model using historical client data and historical requirements data;
extract client data from the onboarding request;
evaluate the client data using the requirements prediction model to determine the onboarding requirements; and
return the onboarding requirements in response to the query.

10. The at least one non-transitory machine-readable medium of claim 8, further comprising instructions that, when executed by the at least one processor, cause the at least one processor to perform operations to:
extract client data from the onboarding request;
determine that a client identifier does not exist for the client data;
generate a unique client identifier for a user using the client data; and
associate the unique client identifier with the onboarding request.

11. The at least one non-transitory machine-readable medium of claim 8, the instructions to deduplicate the onboarding requirements based on a common taxonomy to create a standardized requirements set further comprising instructions to:
apply a fuzzy logic algorithm to the onboarding requirements using the common taxonomy to create a map of a plurality of requirement elements to a requirement element of the common taxonomy; and
replace the plurality of requirement elements with the requirement element of the common taxonomy from the standardized requirements set.

12. The at least one non-transitory machine-readable medium of claim 8,
wherein the user interface elements include a document upload interface.

13. The at least one non-transitory machine-readable medium of claim 8, the instructions to execute the onboarding workflow across internal systems to fulfill requirements of the standardized requirements set using input received from the user interface further comprising instructions to:
determine a system of record to receive a data element included in the input received from the user interface;
transmit the data element to the system of record;
obtain a status response from the system of record; and
compile the status response with a collection of status responses from the internal systems to generate the status of the onboarding request.

14. The at least one non-transitory machine-readable medium of claim 8, further comprising instructions that, when executed by the at least one processor, cause the at least one processor to perform operations to:
generate an onboarding request block for the onboarding request in a distributed ledger; and
update the onboarding request block with the status of the onboarding request.

15. A computer-implemented method for client onboarding comprising:
receiving, at an application programming interface (API) gateway, an onboarding request from a self-service onboarding portal;
querying requirements data for onboarding requirements;
deduplicating the onboarding requirements based on a common taxonomy to create a standardized requirements set;
selecting user interface elements for presentation in a user interface based on the standardized requirements set;
presenting the user interface in the self-service onboarding portal;
executing an onboarding workflow across internal systems to fulfill requirements of the standardized requirements set using input received from the user interface; and
returning a status of the onboarding request to the self-service onboarding portal.

16. The computer-implemented method of claim 15, further comprising:
training, using a machine learning algorithm, a requirements prediction model using historical client data and historical requirements data;
extracting client data from the onboarding request;
evaluating the client data using the requirements prediction model to determine the onboarding requirements; and
returning the onboarding requirements in response to the query.

17. The computer-implemented method of claim 15, further comprising:
extracting client data from the onboarding request;
determining that a client identifier does not exist for the client data;
generating a unique client identifier for a user using the client data; and
associating the unique client identifier with the onboarding request.

18. The computer-implemented method of claim 15, wherein deduplicating the onboarding requirements based on a common taxonomy to create a standardized requirements set further comprises:
applying a fuzzy logic algorithm to the onboarding requirements using the common taxonomy to create a map of a plurality of requirement elements to a requirement element of the common taxonomy; and
replacing the plurality of requirement elements with the requirement element of the common taxonomy from the standardized requirements set.

19. The computer-implemented method of claim 15, wherein the user interface elements include a document upload interface.

20. The computer-implemented method of claim 15, wherein executing the onboarding workflow across internal systems to fulfill requirements of the standardized requirements set using input received from the user interface further comprises:
determining a system of record to receive a data element included in the input received from the user interface;
transmitting the data element to the system of record;
obtaining a status response from the system of record; and
compiling the status response with a collection of status responses from the internal systems to generate the status of the onboarding request.
